(19) United States
(12) Patent Application Publication
(10) Pub. No.: US 2025/0189317 A1
(43) Pub. Date: Jun. 12, 2025

(54) A DEVICE AND METHOD FOR ASSISTING IN NAVIGATING AN AUTONOMOUS VEHICLE ALONG A ROUTE

(71) Applicant: Volvo Autonomous Solutions AB, Göteborg (SE)

(72) Inventors: Rajashekar CHANDRU, Göteborg (SE); Josef KINDBERG, Torslanda (SE); Oskar NORESSON, Mölndal (SE)

(73) Assignee: Volvo Autonomous Solutions AB, Göteborg (SE)

(21) Appl. No.: 18/843,556

(22) PCT Filed: Mar. 3, 2022
(86) PCT No.: PCT/EP2022/055349

§ 371 Date: Sep. 3, 2024

(51) Int. Cl. G01C 21/28; B60W 60/00

(52) U.S. Cl. CPC G01C 21/28; B60W 60/001

(57) ABSTRACT

A method for assisting in navigating an autonomous vehicle along a route is described. The method includes obtaining route information of the route. The route information is indicative of a set of segments of the route. For each respective segment out of the set of segments, the route information is indicative of at least one candidate localization service for positioning the autonomous vehicle in the respective segment. When the autonomous vehicle is travelling in a current segment out of the set of segments, with use of the obtained route information, a subsequent segment out of the set of segments is selected for at least one localization service from the at least one candidate localization service to be used for positioning the autonomous vehicle in the subsequent segment. The selected at least one localization service is at least partially used for positioning the autonomous vehicle in the current segment out of the set of segments.

### TECHNICAL FIELD

The invention relates to a device and method for assisting in navigating an autonomous vehicle along a route. In particular, the invention relates to selecting which localization service(s) to use when navigating the route.

The invention may be applied in any suitable autonomous vehicle, such as e.g. autonomous cars, or autonomous heavy-duty vehicles, such as trucks, buses and construction equipment.

### BACKGROUND

When an autonomous vehicle navigates along a predetermined route, the autonomous vehicle determines its position based on a localization service such as by the use of a Global Navigation Satellite System (GNSS), e.g., Global Positioning System (GPS), and/or by the use of Light Detection and Ranging (Lidar) sensors. Whichever localization service is used for one region of the route, it may not be efficient or possible to use for another region of the route. For example, Lidar sensors only work well when there are objects in proximity of the autonomous vehicle to scan, and satellite systems do not work indoor or when operating close to mountains sides as there is no service towards the satellite systems. Thus, the autonomous vehicle may need to switch localization service when navigating along the route. Typically, this is done by dynamically determining if there is a need for a switch, e.g. by evaluating whether an accuracy of the currently used localization service is deteriorating and/or evaluating whether there is another available localization service which can provide a position of better quality. If so, the autonomous vehicle stops and determines which new localization service to use, activates the associated sensors and continues navigating using the new localization service. Determining the accuracy of the localization services are intensive with regard to computing power, and additionally, is not always accurate as there are not always good reference data to reliably compare positions with. It follows that it is difficult and computationally intensive to also determine which localization service provides the most accurate position for the autonomous vehicle in a given position. Furthermore, switching localization services takes a lot of time, and thus, productivity associated with the autonomous vehicle is reduced as it is delayed in performing its assigned tasks. Hence, there is a need to improve the efficiency of navigation systems of autonomous vehicles.

### SUMMARY

An object of the invention is to provide a method which improves efficiency of navigating autonomous vehicles.

According to a first aspect, the above object is achieved by a method according to claim 1. Hence, there is provided a method for assisting in navigating an autonomous vehicle along a route. The method comprising:
Obtaining route information of the route. The route information is indicative of a set of segments of the route. For each respective segment out of the set of segments, the route information is indicative of at least one candidate localization service for positioning the autonomous vehicle in the respective segment.
When the autonomous vehicle is travelling in a current segment out of the set of segments, with use of the obtained route information, selecting for a subsequent segment out of the set of segments, at least one localization service from the at least one candidate localization service to be used for positioning the autonomous vehicle in the subsequent segment. The selected at least one localization service is at least partially used for positioning the autonomous vehicle in the current segment out of the set of segments.

Due to these features, a more efficient navigation of the autonomous vehicle is achieved due to several reasons. First, since the route information is indicative of the set of segments of the route and indicative of the at least one candidate localization service for positioning the autonomous vehicle in the respective segment, candidate localization services to be used for each respective segment is known in advance, thus removing the need to a frequent need of re-assessing which localization services are accurate enough to use for positioning the autonomous vehicle in the respective segments. The above-mentioned subject matter also enables to always select suitable localization services, for positioning the autonomous vehicle with high accuracy, as only these may be part of the at least one candidate localization service. Furthermore, since at least one localization service is selected which is at least partially used for positioning the autonomous vehicle in the current segment out of the set of segments, the localization service use is overlapped between the current and the subsequent segment such that it is not needed to stop the autonomous vehicle for switching localization services in the different segments.

Optionally, the method further comprises navigating the autonomous vehicle in the subsequent segment based on positioning information from the selected at least one localization service.

Optionally, each respective segment out of the set of segments is indicative of a recorded trajectory. The trajectory may comprise co-ordinates relative to a map comprising the route.

Optionally, each recorded trajectory is indicative of how a recording vehicle previously travelled in the respective segment.

Optionally, the route information is further indicative of: for each respective segment out of the set of segments, the at least one candidate localization service for the respective segment was used for positioning the recording vehicle and/or was available for positioning the recording vehicle, when the recording vehicle recorded the respective segment. In this way, it is possible to select the at least one localization service based on which candidate localization service was possible to use for the recording vehicle. In other words, the selection may be based on prior knowledge of high accuracy localization services.

Optionally, the method further comprises determining the current and/or the subsequent segment for which the autonomous vehicle is travelling in and/or will travel in, based on determining a location of the autonomous vehicle and by using the obtained route information. For example, the location of the autonomous vehicle may first be determined based on a currently used localization service. Comparing the location with the route information may then produce the current segment, and by inference by knowing the order of the set of segments, e.g. as indicated by the route information, also the subsequent segment.

Optionally, selecting the at least one localization service for the subsequent segment comprises determining an availability of the at least one candidate localization service for the subsequent segment.

Optionally, determining the availability of the at least one candidate localization service for the subsequent segment comprises determining whether a sensor to be used for the at least one candidate localization service is activated.

Optionally, for each respective segment out of the set of segments, the route information is indicative of at least one preferred and/or required localization service to be used for positioning the autonomous vehicle in the respective segment. For example, the route information may have been pre-recorded by the recording vehicle such that it is always known which localization sensor is to be used for overlapping between the current segment and the subsequent segment.

Optionally, selecting the at least one localization service for the subsequent segment comprises selecting the at least one preferred and/or required localization service for the subsequent segment.

Optionally, selecting the at least one localization service for the subsequent segment further comprises selecting at least one additional localization service not used for navigating in the current segment out of the set of segments.

Optionally, the at least one candidate localization service comprises the use of any one or more out of:
At least one two-dimensional (2D) Lidar sensor,
at least one three-dimensional (3D) Lidar sensor,
at least one wireless device arranged for positioning the autonomous vehicle in a wireless network,
at least one camera unit, and
a GNSS such as e.g. GPS or any other suitable satellite navigation system.

According to a second aspect, there is provided a control unit configured to perform the method according to the first aspect.

According to a third aspect, there is provided an autonomous vehicle comprising the control unit according to the second aspect. The autonomous vehicle may e.g. be a truck, a passenger car, or any other suitable autonomous vehicle.

Optionally, the autonomous vehicle comprises a set of sensors for use by one or more localization services when navigating the autonomous vehicle along a route. For example, these may be Lidars, cameras, network devices or any combination thereof that may be needed to use any particular localization service.

According to a fourth aspect, there is provided a computer program comprising program code means for performing the method according to the first aspect, when said program is run on a computer.

According to a fifth aspect, there is provided a computer program medium carrying a computer program comprising program code means for performing the method according to the first aspect, when said program is run on a computer.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is an autonomous vehicle according to embodiments herein.

FIG. 2 is a flowchart illustrating a method according to embodiments herein.

FIG. 3a-3b are illustrations of an autonomous vehicle navigating along a route according to embodiments herein.

FIG. 4a-4b are schematic block diagrams illustrating a control unit according to embodiments herein.

### DETAILED DESCRIPTION OF EXAMPLE EMBODIMENTS OF THE INVENTION

Embodiments herein relate to assisting in navigating an autonomous vehicle, in particular with respect to selecting which localization service(s) to use for positioning/locating the autonomous vehicle within a route. A localization service as used herein may be a service used for positioning autonomous vehicles and may refer to the use of one or more specific sensors for positioning purposes and/or any other mechanism used for positioning. In the following embodiments and examples herein, the terms positioning and locating may be used interchangeably. Similarly, the terms location and position may also be used interchangeably when describing embodiments herein.

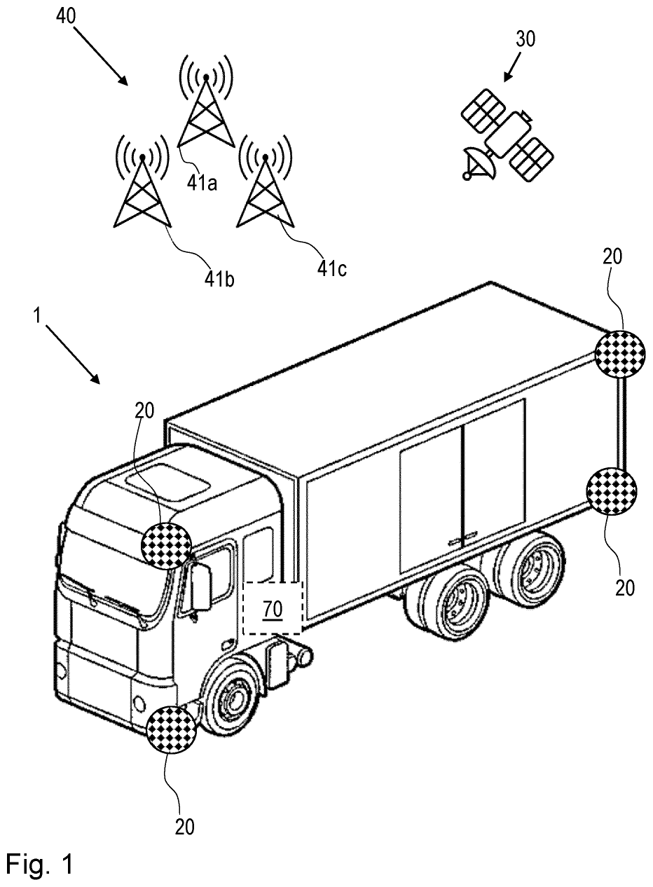

FIG. 1. is a schematic overview of an autonomous vehicle 1 in accordance with embodiments herein. The autonomous vehicle 1 may be configured to autonomously navigate along a route comprising a set of segments. To navigate each respective segment out of the set of segments, the autonomous vehicle 1 need to know its location with respect to the route. To locate the autonomous vehicle 1 with respect to the route, a localization service must be used. To this end, the autonomous vehicle 1 is arranged with a set of sensors 20. Any sensor in the set of sensors 20 may be mounted at any suitable location of the autonomous vehicle 1. For example, the set of sensors 20 may comprise at least one 2D Lidar sensor, at least one 3D Lidar sensor, at least one camera unit, at least one wireless device for network positioning, or any other suitable sensor. In some example scenarios, the at least one 2D Lidar sensor may be arranged on multiple or all sides of the autonomous vehicle 1, e.g. such that the at least one 2D Lidar sensor is capable of scanning all surroundings of the autonomous vehicle 1. The at least one 3D Lidar sensor may be arranged on the roof of the autonomous vehicle 1 to be able to scan 360 degrees around the autonomous vehicle 1. The at least one wireless device may comprise any suitable wireless device which can communicate with any number of suitable network entities 41a-c in a wireless network 40. Based on a signal from the wireless device, the network entities 41a-c may be able to triangulate the position of the wireless device, and thereby also locate the autonomous vehicle 1, and report the location back to the wireless device. Any other suitable methodology for locating the autonomous vehicle 1 with the use of the wireless network 40 may also apply. For example, this may be any suitable telecommunications positioning methodology, e.g. by using ultra-wide band positioning and triangulation. The at least one camera unit may comprise one or more different types of camera units arranged in one or more places of the autonomous vehicle 1. The at least one camera unit may comprise a Red, Green, Blue and Depth (RGBD) sensor camera unit which can record the surroundings and account for depth. The at least one camera unit may additionally or alternatively comprise any one or more out of: Infrared cameras, heat cameras, stereo cameras. Furthermore, the set of sensors 20 may comprise any suitable sensor device for communicating with a GNSS 30 for finding the location of the autonomous vehicle 1 based on communication with satellites in orbit around Earth. The GNSS 30 may for example be GPS or any of its alternatives developed by other countries or regions, e.g. BeiDou, Galileo, GLONASS, or any other suitable satellite positioning system.

Embodiments herein may be performed by a control unit 70. The control unit 70 may be comprised in the vehicle 1 but may also be comprised in any other suitable location. The control unit 70 may be communicatively connected with any one or more out of the: set of sensors 20, the GNSS 30, and the wireless network 40. The control unit 70 may further be able to actuate the navigation of the autonomous vehicle 1 or at least be able to indicate which localization service shall be used for positioning when navigating the autonomous vehicle 1.

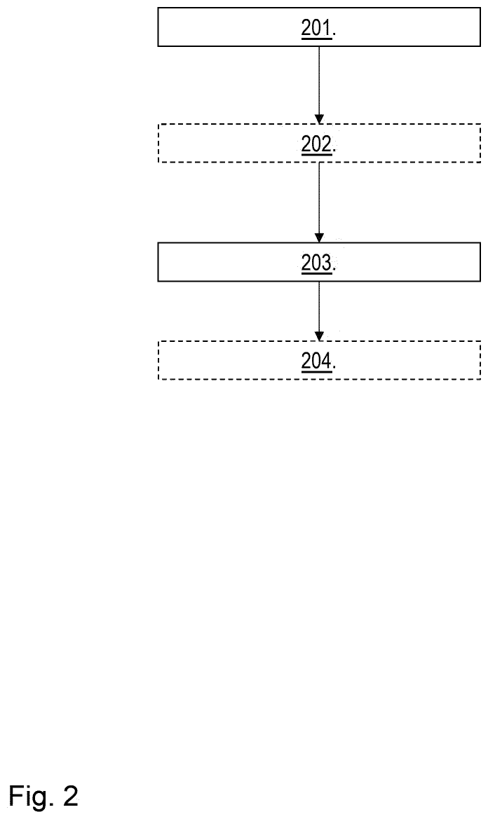

FIG. 2 illustrates a method for assisting in navigating the autonomous vehicle 1 along a route according to embodiments herein. The method may be performed by the control unit 70. The method comprises the following actions described below, which actions may be taken in any suitable order. Optional actions are indicated by dashed boxes in FIG. 2.

### Action 201

The method comprises obtaining route information of the route. The route information is indicative of a set of segments of the route. Each respective segment may thus correspond to a respective part of the route. The route may be organized as a series of paths in one direction from a start point to an end point. The set of segments may be ordered in a list from start to finish.

For each respective segment out of the set of segments, the route information is indicative of at least one candidate localization service for positioning the autonomous vehicle 1 in the respective segment.

In some embodiments, each respective segment out of the set of segments is indicative of a recorded trajectory. Each respective trajectory may be a respective set of coordinates, each indicating how the autonomous vehicle 1 should drive in each respective segment. The coordinates may be relative some reference point in the route, e.g. with respect to a map of an environment comprising the route.

In some embodiments, each recorded trajectory is indicative of how a recording vehicle previously travelled in the respective segment. In other words, the recording vehicle travels the route and records the trajectories for each segment of how the autonomous vehicle should drive in each segment.

In some embodiments, the route information is further indicative of: for each respective segment out of the set of segments the at least one candidate localization service for the respective segment was used for positioning the recording vehicle and/or was available for positioning the recording vehicle, when the recording vehicle recorded the respective segment. In other words, when the recording vehicle records the trajectories of the segments, the recording vehicle also records which localization service was used and/or was available for use for the recording vehicle. In this way, the autonomous vehicle 1 is enabled to travel the same or similar trajectories as the recording vehicle, and is capable of using localization services that are known to be possible to use for positioning vehicles for each respective segment.

In some embodiments, for each respective segment out of the set of segments the route information is indicative of at least one preferred and/or required localization service to be used for positioning the autonomous vehicle 1 in the respective segment. For example, the at least one preferred and/or required localization service may be the localization service used by the recording vehicle when recording the trajectories for each segment.

The recording vehicle may, when recording the respective segments, determine which localization services are most accurate for each respective segment, and record these to be indicated in the route information as part of the at least one candidate localization service. The recording vehicle may at least partially navigate the set of segments to record them for use of embodiments herein, and thus, the recording vehicle have time to switch between all possible localization services to estimate their accuracy for navigating each respective segment. When the respective accuracy of the localization services are above a predefined threshold, the recording vehicle may decide to make them part of the at least one candidate localization service for the respective segment. Thus the at least one candidate localization service for each respective segment may fulfil a predetermined navigation accuracy threshold.

For example, 20 and 3D Lidar sensors may typically be good for use when positioning the autonomous vehicle in segments which have good permanent features around, e.g. tunnels, and thus, the recording vehicle may determine that these Lidar sensors are to be used by the at least one candidate localization service for positioning the autonomous vehicle 1 in these segments. Similarly, GPS may be used with high accuracy in segments with open sky away from high walls and/or mountains, cameras may be used in well-lit segment with good surrounding features. The recording vehicle may know the advantages of each localization service and their respective sensors, and by this knowledge, use heuristics for determining which localization services should be part of the at least one candidate localization service for each respective segment.

In some embodiments, the at least one candidate localization service comprises the use of any one or more out of:
at least one 2D Lidar sensor,
at least one 3D Lidar sensor,
at least one wireless device arranged for positioning the autonomous vehicle 1 in the wireless network 40,
at least one camera unit, and
the GNSS 30.

The above-mentioned sensors and devices may be part of the set of sensors 20, or may be any one or more other device, sensor, actuator that may be used by the at least one candidate localization service for positioning the autonomous vehicle 1.

### Action 202

In some embodiments, the method further comprises determining a current and/or a subsequent segment for which the autonomous vehicle 1 is travelling in and/or will travel in. The subsequent segment may be the immediate next segment in the set of segments with respect to the current segment.

Determining the current and/or the subsequent segment may comprise determining a location of the autonomous vehicle 1 and use the obtained route information to determine the current and/or subsequent segment. The location of the autonomous vehicle 1 may be determined in any suitable manner. For example, the location of the autonomous vehicle may be determined based on a currently used localization service. The location may be mapped to a current segment based on the route information. Since the route information comprise information of all segments in the set of segments, knowing the current segment implies knowing the next segment, i.e. the subsequent segment. A mapping between locations and respective segments may be stored in the route information such that knowing a location of the autonomous vehicle 1 is sufficient to directly map the location to a segment. In an alternative embodiment, for example when initiating the route in a start segment, the current and/or subsequent segment may be indicated by a manual input and/or be implied by initiating the route.

### Action 203

The method comprises, when the autonomous vehicle 1 is travelling in the current segment out of the set of segments, with use of the obtained route information, selecting for a subsequent segment out of the set of segments, at least one localization service from the at least one candidate localization service to be used for positioning the autonomous vehicle 1 in the subsequent segment. The selected at least one localization service is at least partially used for positioning the autonomous vehicle 1 in the current segment out of the set of segments. In other words, there is an overlap between the at least one localization service used for positioning in the current segment and the at least one localization service used for positioning in the subsequent segment. In this way, there is no need to the autonomous vehicle 1 for switching localization services when switching segments.

In some embodiments, selecting the at least one localization service for the subsequent segment comprises determining an availability of the at least one candidate localization service for the subsequent segment. Determining the availability of the at least one candidate localization service for the subsequent segment may further comprise determining whether sensors to be used for the at least one candidate localization service is functioning properly, e.g. determining whether there is a sensor malfunction or whether the at least one candidate localization service is offline, e.g. due to external conditions such as the wireless network 40 cannot properly locate the autonomous vehicle, or GNSS 30 satellites are offline.

In some embodiments, determining the availability of the at least one candidate localization service for the subsequent segment comprises determining whether a sensor to be used for the at least one candidate localization service is activated. If a needed sensor is deactivated, the method may comprise activating the needed at least one sensor for the at least one candidate localization service.

In some embodiments, selecting the at least one localization service for the subsequent segment comprises selecting the at least one preferred and/or required localization service for the subsequent segment. In this way, it is ensured that the autonomous vehicle 1 at least uses localization services proven to work well for positioning in the set of segments.

In some embodiments, selecting the at least one localization service for the subsequent segment further comprises selecting at least one additional localization service not used for navigating in the current segment out of the set of segments. In other words, the at least one localization service may overlap localization service use for the current and the subsequent segment, but may also use additional localization services, e.g. which may in a similar way, by means of iterating the described method herein, be overlapped with further localization services in further subsequent segments.

In some embodiments, the selected at least one localization service for the subsequent segment comprises all of, or a subset of, the localization services in the at least one candidate localization service for the subsequent segment. This may be since one of the localization services indicates a temporary or permanent low accuracy, e.g. due to malfunctioning sensors or some temporal unpredicted event.

In some embodiments, selecting the at least one localization service for the subsequent segment further comprises selecting the at least one localization service from the at least one candidate localization service based on a priority of localization services. The priority may be related to an accuracy of a particular localization service in the subsequent segment. The priority may be pre-defined for certain type of segments and/or may be indicated by the route information. The priority may also be based on estimating the current accuracy of each localization service, e.g. based on a current state of their respective sensors.

### Action 204

In some embodiments, the method further comprises navigating the autonomous vehicle 1 in the subsequent segment based on positioning information from the selected at least one localization service. Navigation of the autonomous vehicle 1 in the subsequent segment based on the selected at least one localization service for positioning the autonomous vehicle 1 in the subsequent segment may be initiated at a switching point between the current segment and the subsequent segment. The switching point may be indicated by the route information. The switching point may relate to a short distance of overlap of the current and subsequent segment. In these embodiments, at the switching point, localization services used in the at least one localization service for the current segment not to be used for positioning the autonomous vehicle 1 in the subsequent segment are deactivated. In a similar manner in these embodiments, localization services to be used for positioning the autonomous vehicle 1 in the subsequent segment not used in the current segment are activated at the switching point.

The method according to Actions 201-204 above may further repeat iteratively over all of the set of segments. In this way, it is possible to overlap the localization service usage in all of the segments such that each segment share at least one localization service with its respective subsequent and preceding segments. Therefore, the autonomous vehicle 1 may minimize the need for stopping the autonomous vehicle 1 to change localization services.

The methods will now be further explained and exemplified in below embodiments. These below embodiments may be combined with any suitable embodiment as described above.

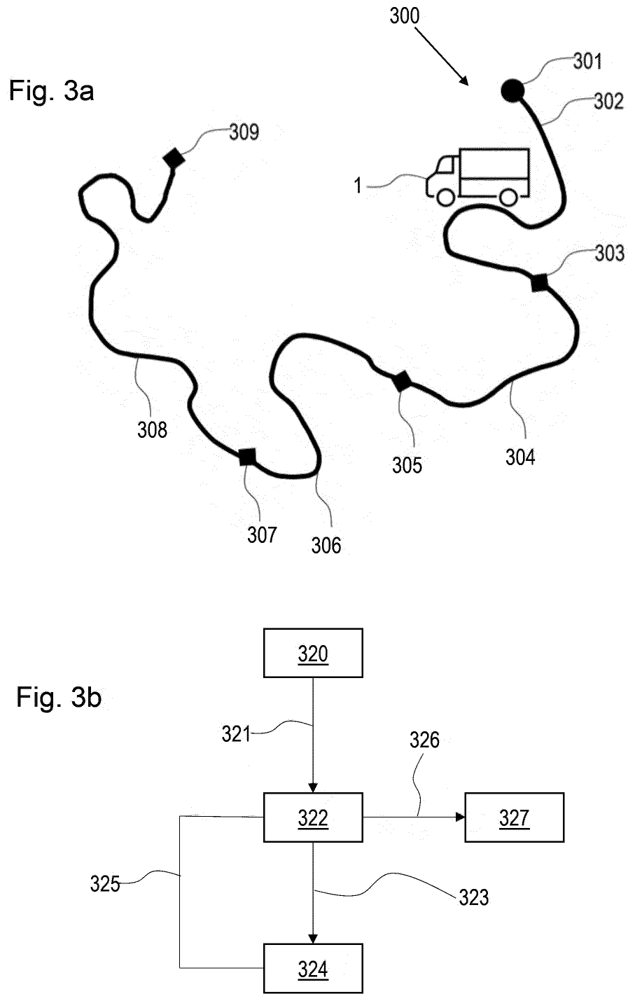

FIG. 3a. illustrates an example scenario when the autonomous vehicle 1 travels in, and navigates along a route 300. The route 300 comprises a set of segments, which in this example consists of a first segment 302, a second segment 304, a third segment 306, and a fourth segment 308. The route 300 comprising the set of segments 302, 304, 306, 308 have been pre-recorded by a recording vehicle into route information, e.g. obtained by the autonomous vehicle 1 as in Action 201 above. It should be noted that route 300 is only to be considered an illustrative example and routes comprising more or less than four segments may also be applicable to embodiments herein. It should further be noted that in this example scenario, when describing that actions are taken by the autonomous vehicle 1, the actions may additionally or alternatively be made by any entity controlling or assisting the autonomous vehicle 1 for these actions, e.g. the control unit 70.

### Initiating the Route

In the example scenario of FIG. 3a, the autonomous vehicle 1 starts at a start point 301 which may indicate the start of the first segment 302. A first at least one localization service to be used for positioning the autonomous vehicle 1 when navigating the first segment 302 is selected. The first at least one localization service may be selected when starting the route 300, or in any suitable manner in advance to initiating travel on the route 300. In some embodiments the first at least one localization service is selected from the at least one candidate localization service associated with the segment in the route information, e.g. similar to Action 203 above.

### Navigating in the First Segment

In the example scenario of FIG. 3a, the autonomous vehicle 1 may then start to navigate the first segment 302, and may further select a second at least one localization service for positioning the autonomous vehicle 1 in the second segment 304. Selecting the second at least one localization service may be performed concurrently to navigating the first segment 302, e.g. as in actions 201-204 above. In this example scenario, the first at least one localization service comprises the use of multiple cameras, 3D Lidar and 2D Lidar, and the selected second at least one localization service comprises the use of 3D and 2D Lidar. The switch from using the first at least one localization service to using the second at least one localization service happens at a first switching point 303 between the first segment 302 and the second segment 304. Since both the first and second at least one localization service comprise the use of both 2D and 3D Lidar, the autonomous vehicle 1 de-activates the multiple cameras at the first switching point 303 and continues to navigate the second segment 304 using the 2D and 3D Lidar without a need to stop when changing from the first at least one localization service to the second at least one localization service

### Navigating in the Second Segment 304

In the example scenario of FIG. 3a, when navigating the second segment 304, a third at least one localization service is selected for the third segment 306, e.g. as in actions 201-204 above. The third at least one localization service comprises the use of 2D Lidar, 3D Lidar and GPS. When the autonomous vehicle reaches a second switching point 305, the autonomous vehicle 1 activates the GPS and continues navigation in the third segment 306 without a need to stop when changing from the second at least one localization service to the third at least one localization service.

### Navigating in the Third Segment 306

In the example scenario of FIG. 3a, when navigating the third segment 306, a fourth at least one localization service is selected for the fourth segment 308, e.g. as in actions 201-204 above. The fourth at least one localization service comprises the use of GPS. When the autonomous vehicle reaches a third switching point 307, the autonomous vehicle 1 de-activates the 2D Lidar and 3D Lidar and continues navigation in the fourth segment 308 without a need to stop when changing from the third at least one localization service to the fourth at least one localization service.

### Navigating in the Fourth Segment 308

In the example scenario of FIG. 3a, the autonomous vehicle 1 navigates the fourth segment 308 until reaching an end point 309, signifying the end of route 300. When this occurs the autonomous vehicle 1 may continue on any other suitable route (not shown) and may concurrently to navigating the fourth segment 308 select localization services to use for positioning the autonomous vehicle 1 when navigating these routes.

FIG. 3b. is a flowchart which illustrates an example scenario of embodiments herein. A storage medium 320 stores route information of a route recorded by a recording vehicle. The route information may comprise all information of all segments of the route and which localization services to use for navigating the autonomous vehicle 1 in each respective set of segments. The route information may be same or similar as described in actions 201-204 above. A navigation system 322 of the autonomous vehicle 1 obtains 321 the route information from the storage medium 320. The navigation system 322 determines a trajectory for how the autonomous vehicle 1 should drive, e.g. to most accurately follow a recorded trajectory indicated by the route information. To determine the trajectory for the autonomous vehicle 1, the navigation system 322 needs to know a current position of the autonomous vehicle 1. The position of the autonomous vehicle 1 may be determined by the use of a localization system 324. During autonomous navigation in a current segment, the navigation system 322 requests 323 the localization system 324 which localization services need to be active based on the obtained 321 route information from the storage medium 320. The requested localization services may e.g. be the at least one localization services selected in action 203 above. The request may be in response to the route information indicating an upcoming overlap section and/or a switching point of the use of localization services. The localization system 324 attempts to activate all of the requested localization services and associated sensors. If any of the localization services or their associated sensors malfunction or show a too low accuracy, e.g. below the predetermined navigation accuracy threshold, they will not be activated. The localization system 324 may use the successfully activated localization services for positioning the autonomous vehicle 1 and may further send 325 positioning information to the navigation system 322. The positioning information may comprise an indication of the location of the autonomous vehicle 1. The positioning information may additionally comprise an indication of which localization services are activated. The navigation system 322 determines the trajectory for the autonomous vehicle 1 based on the sent 325 positioning information and configures 326 a trajectory control unit 327 comprised in the autonomous vehicle 1 to drive the autonomous vehicle 1 according to the determined trajectory. When the sent 325 positioning information indicates that a required localization service has not been activated, and/or if no positioning information is available, the navigation system 322 configured the trajectory control unit 327 to stop autonomous driving of the autonomous vehicle 1.

Any one or more of the above exemplified storage medium 320, navigation system 322, localization system 324, and trajectory control unit 327 may be part of the autonomous vehicle 1, e.g. as a part of the control unit 70. Some of the exemplified units, e.g. the storage medium 320, may be arranged at a remote location, e.g. as part of a cloud service on at least one remote server.

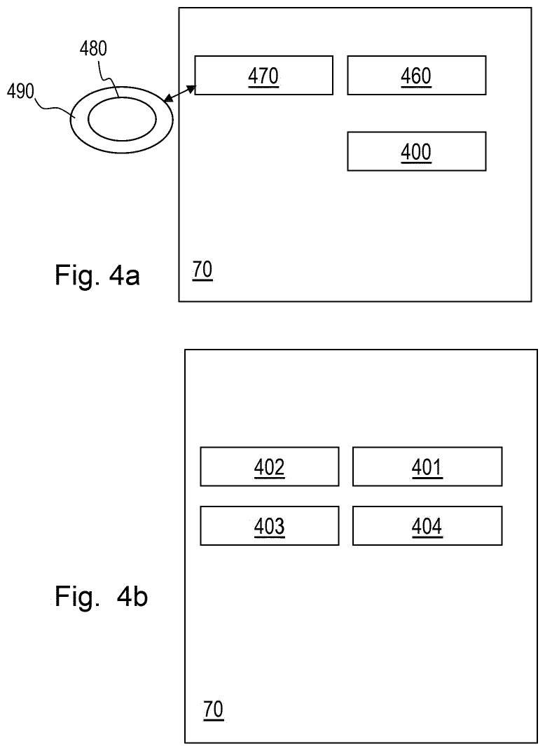

To perform the method actions described herein, the control unit 70 may be configured to perform any one or more of the above actions 201-204 or any of the other examples or embodiments herein. The control unit 70 may for example comprise an arrangement depicted in FIGS. 4a and 4b.

The control unit 70 may comprise an input and output interface 400 configured to communicate with any necessary components or entities of embodiments herein. The input and output interface 400 may comprise a wireless and/or wired receiver (not shown) and a wireless and/or wired transmitter (not shown). The control unit 70 may be arranged in any suitable location of the autonomous vehicle 1, e.g. as part of a computer comprised in a luggage compartment of the autonomous vehicle 1. The control unit 70 may use the input and output interface 400 to control and communicate with sensors, actuators, and interfaces in the autonomous vehicle 1 using any one or more out of: Controller Area Network (CAN), ethernet cables, Wi-Fi, or other network interfaces.

The control unit 70 may be configured to, e.g. by means of an obtaining unit 401 in the control unit 70, obtain route information of a route. The route information being indicative of a set of segments, e.g. as described in above actions 201-204.

The control unit 70 may be configured to, e.g. by means of a determining unit 402 in the control unit 70, determine the current and/or the subsequent segment for which the autonomous vehicle 1 is travelling in and/or will travel in.

The control unit 70 may be configured to, e.g. by means of a selecting unit 403 in the control unit 70, select for a subsequent segment out of the set of segments, at least one localization service from at least one candidate localization service to be used for positioning the autonomous vehicle in the subsequent segment.

The control unit 70 may be configured to, e.g. by means of a navigating unit 404 in the control unit 70, navigate the autonomous vehicle 1 in the subsequent segment based on positioning information from the selected at least one localization service.

The embodiments herein may be implemented through a processor or one or more processors, such as the processor 460 of a processing circuitry in the control unit 70 depicted in FIG. 4a, together with computer program code for performing the functions and actions of the embodiments herein. The program code mentioned above may also be provided as a computer program medium, for instance in the form of a data computer readable medium carrying computer program code for performing the embodiments herein when being loaded into the control unit 70. One such computer readable medium may be in the form of a memory stick. The computer program code may furthermore be provided as pure program code on a server and downloaded to the control unit 70.

The control unit 70 may further comprise a memory 470 comprising one or more memory units. The memory 470 comprises instructions executable by the processor in control unit 70. The memory 470 is arranged to be used to store e.g. information, indications, data, configurations, route information, and applications to perform the methods herein when being executed in the control unit 70. The memory 470 may in some embodiments comprise the storage medium 320.

In some embodiments, a computer program 480 comprises instructions, which when executed by a computer, e.g. the at least one processor 460, cause the at least one processor of the control unit 70 to perform the actions 201-204 above.

In some embodiments, a computer-readable storage medium 490 comprises the respective computer program 480. The computer-readable storage medium 490 may comprise program code for performing the steps of any one of actions 201-204 above when said program product is run on a computer, e.g. the at least one processor 460.

Those skilled in the art will appreciate that the units in the control unit 70 described above may refer to a combination of analogue and digital circuits, and/or one or more processors configured with software and/or firmware, e.g. stored in the control unit 70, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

It is to be understood that the present invention is not limited to the embodiments described above and illustrated in the drawings; rather, the skilled person will recognize that many changes and modifications may be made within the scope of the appended claims.

1. A method for assisting in navigating an autonomous vehicle along a route, the method comprising:
obtaining route information of the route, wherein the route information is indicative of a set of segments of the route, and for each respective segment out of the set of segments, the route information is indicative of at least one candidate localization service for positioning the autonomous vehicle in the respective segment,
determining a subsequent segment for which the autonomous vehicle will travel in, based on determining a location of the autonomous vehicle and by using the obtained route information:
wherein the subsequent segment is the immediate next segment in the set of segments with respect to the current segment,
when the autonomous vehicle is travelling in a current segment out of the set of segments, with use of the obtained route information, selecting for the subsequent segment out of the set of segments, at least one localization service from the at least one candidate localization service to be used for positioning the autonomous vehicle in the subsequent segment, and wherein the selected at least one localization service is used for positioning the autonomous vehicle in the current segment out of the set of segments, and
selecting the at least one localization service for the subsequent segment further comprises selecting at least one additional localization service not used for navigating in the current segment out of the set of segments.

2. The method according to claim 1, wherein the method further comprises navigating the autonomous vehicle in the subsequent segment based on positioning information from the selected at least one localization service.

3. The method according to claim 1, wherein each respective segment out of the set of segments is indicative of a recorded trajectory.

4. The method according to claim 3, wherein each recorded trajectory is indicative of how a recording vehicle previously travelled in the respective segment.

5. The method according to claim 3, wherein the route information is further indicative of: for each respective segment out of the set of segments, the at least one candidate localization service for the respective segment was used for positioning the recording vehicle and/or was available for positioning the recording vehicle, when the recording vehicle recorded the respective segment.

6. (canceled)

7. The method according to claim 1, wherein selecting the at least one localization service for the subsequent segment comprises determining an availability of the at least one candidate localization service for the subsequent segment.

8. The method according to claim 7, wherein determining the availability of the at least one candidate localization service for the subsequent segment comprises determining whether a sensor to be used for the at least one candidate localization service is activated.

9. The method according to claim 1, wherein for each respective segment out of the set of segments, the route information is indicative of at least one preferred and/or required localization service to be used for positioning the autonomous vehicle in the respective segment.

10. The method according to claim 9, wherein selecting the at least one localization service for the subsequent segment comprises selecting the at least one preferred and/or required localization service for the subsequent segment.

11. (canceled)

12. The method according to claim 1, wherein the at least one candidate localization service comprises the use of any one or more out of:
at least one two-dimensional, 2D, Light Detection and Ranging, Lidar, sensor,
at least one three-dimensional, 3D, Light Detection and Ranging, Lidar, sensor,
at least one wireless device arranged for positioning the autonomous vehicle in a wireless network,
at least one camera unit, and
a Global Navigation Satellite System, GNSS.

13. A control unit configured to perform the method according to claim 1.

14. An autonomous vehicle comprising the control unit according to claim 13.

15. The autonomous vehicle according to claim 14 further comprising a set of sensors for use by one or more localization services when navigating the autonomous vehicle along a route.

16. A computer program comprising program code means for performing the steps of claim 1 when said program is run on a computer.

17. A non-transitory computer program medium carrying a computer program comprising program code for performing the steps of claim 1 when said program code is run on a computer.
